(19) United States
(12) Patent Application Publication
(10) Pub. No.: US 2009/0133433 A1
(43) Pub. Date: May 28, 2009

(54) Refrigerator unit and/or freezer unit

(76) Inventors: Viktor Laube, Ochsenhausen (DE); Matthias Wiest, Ochsenhausen (DE); Klaus Oelmaier, Ochsenhausen (DE)

Correspondence Address: DILWORTH & BARRESE, LLP, 333 EARLE OVINGTON BLVD., SUITE 702, UNIONDALE, NY, 11553, US

(21) Appl. No.: 12/287,107

(22) Filed: Oct. 6, 2008

(30) Foreign Application Priority Data
Oct. 5, 2007 (DE) 20 2007 013 946.2
Oct. 26, 2007 (DE) 20 2007 014 888.7

(51) Int. Cl. F25D 11/02; F25D 19/00; F25B 39/02; F25D 27/00; B67D 5/62

(52) U.S. Cl. 62/441; 62/449; 62/515; 62/264; 62/389

(57) ABSTRACT

The present invention relates to a refrigerator unit and/or a freezer unit having at least one refrigeration space and/or freezing space as well as having at least one drawer arranged in the refrigeration space and/or freezing space, with a space being located beneath the drawer in the refrigeration space and/or freezing space, with one or more components of the unit being arranged in the space.

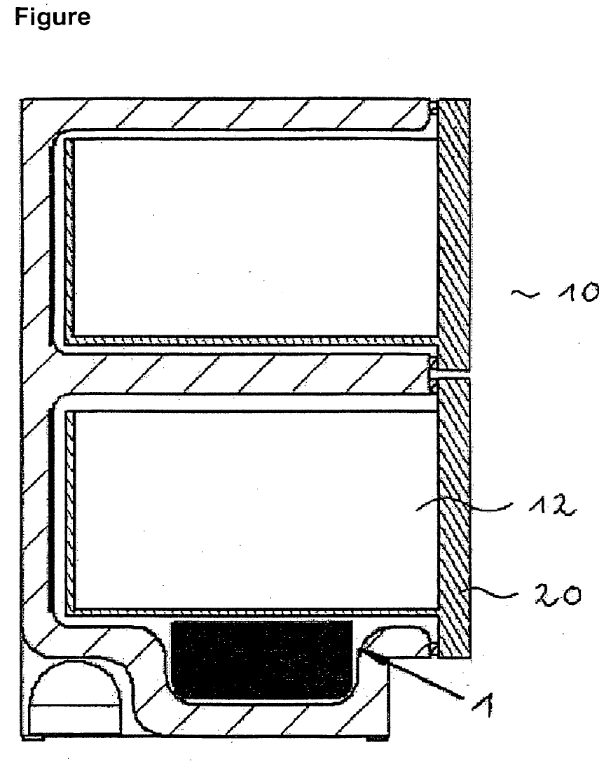

The present invention relates to a refrigerator unit and/or a freezer unit having at least one refrigeration space and/or freezing space as well as having at least one drawer arranged in the refrigeration space and/or freezing space, with a free space being located beneath the drawer in the refrigeration space and/or freezing space.

A free space in particular arises in the unit base beneath the lowest drawer compartment with undercounter refrigerator units or with undercounter freezer units having drawer compartments as well as having a base unit. This free space is usually not used for the storage of foodstuffs since it is not accessible or is only accessible with great difficulty for the user of the unit.

It is the underlying object of the present invention to further develop a refrigerator unit and/or a freezer unit of the initially named kind such that the useful capacity of the refrigeration space and/or freezing space is enlarged with respect to previously known units.

This object is solved by a refrigerator unit and/or a freezer unit having the features of claim 1.

Provision is made in accordance with this that one or more components of the unit are arranged in the named space located beneath the drawer. In accordance with the invention, provision is thus made that the named space is given a meaningful use in that one or more unit components are arranged therein. These components therefore do not need to be accommodated in other regions of the unit so that the usable region of the refrigeration space and/or freezing space can be made comparatively large. At the same time, the advantage is achieved that the actual refrigeration space and/or freezing space remains completely reserved for the goods to be stored. A further advantage consists of the components in particular also being protected against damage, for example by striking, piercing, etc.

A further advantage of the arrangement of unit components in the named space consists of their being able to be accommodated in a comparatively maintenance friendly manner. Only the respective drawer has to be pulled out or removed for the purpose of maintenance and the components are then easily accessible for a service engineer or for the user.

Accordingly, provision is made in a preferred embodiment of the invention that at least the drawer above the named space can be completely removed from the unit.

The components of the unit can, for example, be components serving cold production. It is, for example, conceivable that an evaporator and/or a fan and/or air guidance elements are arranged in the space.

It is also conceivable to provide an evaporator heating and/or a refrigerant collector in the named space.

A complete evaporator module having some or all components belonging thereto such as a fan associated with the evaporator and/or a heating and/or refrigerator collector and/or air guidance elements can generally also be arranged.

Provision is made in a further embodiment of the invention that the component or components of the unit are components of a water supply of the unit.

It is, for example, conceivable that the unit has a dispenser for water, in particular for cold water and/or an ice cube maker which is in communication with the water supply.

It is conceivable to arrange a water tank in the named space, for example, and/or cut-off devices and/or filter devices and/or lines or line elements which are needed for the corresponding treatment or filtering and guidance of the water.

It is also conceivable that means for the enrichment of water with CO₂ such as one or more CO₂ cartridges and the like are provided in the space.

Provision is made in a further embodiment of the invention that a tank for additives such as flavoring agents, etc. for the water to be output or air is provided in the space.

Provision can furthermore be made that means for radiation, such as for UV radiation, sterilization, for the increase of the vitamin content of the stored goods, etc. are arranged in the space.

Provision can be made in an embodiment of the invention that the component arranged in the space is a means for radiation which emit a light spectrum such that the vitamin content of the goods located in the drawer above is increased. This requires that the base of the drawer has sufficient light permeability.

It is also conceivable that the component or components of the unit is/are components which serve the control and/or regulation of the unit or of parts of the unit such as a water dispenser, etc.

Provision is made in a further embodiment of the invention that the unit has a base unit. Provision can be made in this respect that the named space is arranged in the region of the unit base.

The unit in accordance with the present invention can be an undercounter refrigerator unit and/or freezer unit; but other unit designs are also covered by the invention.

The only FIGURE shows a refrigerator unit and/or freezer unit in accordance with the present invention in a schematic sectional view.

In the only FIGURE, the space of the unit 10 utilized in accordance with the invention is marked by the reference numeral 1. Reference numeral 12 denotes a refrigeration space in which drawers 20 are arranged. The space 1 in which, in accordance with the invention, one or more unit components are arranged is located beneath the lowest drawer 20.

In the rear base region, there is a base unit on which components serving cold production such as a compressor and/or a fan and/or an evaporation tray and/or the electronics and/or a condenser can be arranged.

The fronts of the drawers 20 in the embodiment shown simultaneously form the front of the unit. Other designs are naturally also covered by the invention. It is conceivable to form the unit front by a door and to arrange one or more drawers in the refrigeration space and/or freezing space which are accessible when the door is open.

As stated, the space 1 located beneath the lowest drawer 20 can, for example, meaningfully be used as follows:

Components such as a water tank with the associated cut-off devices, regulating devices, filter devices and line devices can be accommodated. It is also conceivable to position devices for the enrichment of the cold water with CO₂ in the space together with a CO₂ tank.

It is likewise conceivable to arrange any desired components such as filters, valves or lines in the space.

Advantages of the present invention consist inter alia of the fact that the refrigeration space and/or freezing space is completely reserved for the goods to be stored and that this space can be designed to be comparatively large since unit components are arranged at least partly beneath the drawer compartment in the named free space.

Apart from this, it is achieved as an advantage that the components in the space are very easily accessible and can therefore be serviced without problem in particular when the drawer arranged above the space is completely removable. A further advantage consists of the fact that the components located in the space are also protected particularly effectively against damage such as damage from striking, piercing, etc.

1. A refrigerator unit and/or a freezer unit (10) having at least one refrigeration space and/or freezing space (12) as well as having at least one drawer (20) arranged in the refrigeration space and/or freezing space (12), with a space (1) being located beneath the drawer (20) in the refrigeration space and/or freezing space (12), wherein one or more components of the unit (10) are arranged in the space (1).

2. A refrigerator unit and/or a freezer unit (10) in accordance with claim 1, wherein the component or components of the unit (10) are components serving cold production.

3. A refrigerator unit and/or a freezer unit (10) in accordance with claim 1, wherein the component or components of the unit (10) is/are an evaporator.

4. A refrigerator unit and/or a freezer unit (10) in accordance with claim 1, wherein the component or components of the unit (10) is/are a fan and/or air guidance elements.

5. A refrigerator unit and/or a freezer unit (10) in accordance with claim 1, wherein the component or components of the unit (10) is/are an evaporator heating.

6. A refrigerator unit and/or a freezer unit (10) in accordance with claim 1, wherein the component or components of the unit (10) is/are a refrigerant collector.

7. A refrigerator unit and/or a freezer unit (10) in accordance with claim 1, wherein the component or components of the unit (10) is/are components of a water supply of the unit (10).

8. A refrigerator unit and/or a freezer unit (10) in accordance claim 7, wherein the component or components of the unit (10) is/are a water tank.

9. A refrigerator unit and/or a freezer unit (10) in accordance with claim 7, wherein the component or components of the unit (10) is/are cut-off devices and/or filter devices and/or lines.

10. A refrigerator unit and/or a freezer unit (10) in accordance with claim 7, wherein the component or components of the unit (10) is/are means for the enrichment of water with CO₂.

11. A refrigerator unit and/or a freezer unit (10) in accordance with claim 7, wherein the component or components of the unit (10) is/are a tank having additives for water.

12. A refrigerator unit and/or a freezer unit (10) in accordance with claim 1, wherein the component or components of the unit (10) is/are components for the control and/or regulation of the unit (10) or of parts of the unit (10).

13. A refrigerator unit and/or a freezer unit (10) in accordance with claim 12, wherein the component or components of the unit (10) is/are a control or regulation device for a water dispenser.

14. A refrigerator unit and/or a freezer unit (10) in accordance with claim 1, wherein the unit (10) has a base unit.

15. A refrigerator unit and/or a freezer unit in accordance with claim 1, wherein the unit (10) is an undercounter unit.

16. A refrigerator unit and/or a freezer unit (10) in accordance with claim 1, wherein the component or components of the unit (10) is/are means for radiation, sterilization or for the vitamin increase of the stored goods.

17. A refrigerator unit and/or a freezer unit (10) in accordance with claim 1, wherein at least the base of the drawer (20) is made translucent or transparent.

18. A refrigerator unit and/or a freezer unit (10) in accordance with claim 8, wherein the component or components of the unit (10) is/are cut-off devices and/or filter devices and/or lines.

19. A refrigerator unit and/or a freezer unit (10) in accordance with claim 18, wherein the component or components of the unit (10) is/are means for the enrichment of water with CO₂.

20. A refrigerator unit and/or a freezer unit (10) in accordance with claim 9, wherein the component or components of the unit (10) is/are means for the enrichment of water with CO₂.
